(19) United States
(12) Patent Application Publication
(10) Pub. No.: US 2017/0311709 A1
(43) Pub. Date: Nov. 2, 2017

(54) PAINT BRUSH WITH CLIP ATTACHMENT

(71) Applicant: David McInerney, Manalapan, NJ (US)

(72) Inventor: David McInerney, Manalapan, NJ (US)

(21) Appl. No.: 15/583,463

(22) Filed: May 1, 2017

Related U.S. Application Data
(60) Provisional application No. 62/330,210, filed on May 1, 2016.

(51) Int. Cl. A46B 17/02; B44D 3/12; B25G 1/10; F16M 13/02

(52) U.S. Cl. CPC A46B 17/02; F16M 13/02; B44D 3/123; B25G 1/10; A46B 2200/202

(57) ABSTRACT

Disclosed is an improved paintbrush with an integrated clip. The integrated clip rotates, and when not in use does not hinder the user. The design allows for a user to use the paintbrush unfettered until the user desires to hang the paintbrush for storage or drying. When the user desires to use the clip, it is rotated from within the paint brush handle to the position of use. When the user desires to utilized the paintbrush for painting, the clip can be stored within the paintbrush handle in a manner where is does not interfere.

### PRIORITY

This application claims the benefit of U.S. Provisional Application No. 62/330,210, filed May 1, 2016.

### BACKGROUND

Various tools exist to assist a painter in completing a job. These tools are aimed at both professional and amateur painters. The tools which exist range from things that are meant to make painting easier, to tools designed to make painting cleaner. Painting, because it involves surface finishes which are meant to last is a balance between the difficulty cleaning the painting equipment and the surface finish quality. In order to maintain a consistent appearance on walls and other surfaces great care must be taken to ensure that dirt, dust, paint fragments, and other debris are not transferred from equipment to the surface which is being painted.

The paint brush is one of the main tools utilized by the painter. Once painting begins the paint brush cannot be put down without risking cross contamination between the resting place and the paint supply. Many attempts exist to address this problem, these include trays, clips, hooks, and even specially designed brushed which include clips. Each of these attempts to address this problem suffer from one or more of the following: they are expensive, they are cumbersome, the mechanism gets in the way of painting, or the device is prone to breakage.

One method to reduce the amount of particulate which accumulate on the paint brush includes suspending the paint brush over the paint container. Suspending the brush serves to shield the brush from direct contact with particulates. Several methods allow for a paint brush to be suspended over the paint container. Clips exist which allow for the paintbrush to be attached to the outside of a paint container and to be suspended over the paint. The existing clips do not allow the painter to continue working unhindered when the brush is not connected to the paint container.

For the foregoing reasons, there is a need for a more versatile, less obtrusive paint brush suspension system.

### SUMMARY

The present invention is directed to a paint brush that satisfies this need. The paint brush system comprises a paint brush, the paint brush has a handle with a clip integrated within the handle. The clip is connected to the handle in such a manner as to allow the clip to rotate within the handle for storage when the clip is not in use.

### DESCRIPTION

A preferred embodiment of the present invention provides a paint brush with a handle, with an integrated clip in said handle. The integrated clip is connected to the paint brush with a connector that allows the clip to rotate along an attachment point. When the clip is in use, the clip can be rotated by a user in order to expose a connector which allows the paint brush to be suspended over a container by a clip end located at the end of an elongated section of the clip. The handle of the present invention has a front surface and a rear surface. When the clip is not in use, the user can rotate the clip into a pocket, to a position where is does not hinder the use of the paint brush. The brush handle can be manufactured from numerous materials from wood, metal, to various thermoplastic materials so long as the material is strong enough to withstand the usage of the brush.

An alternative embodiment of the present invention provides a paint brush with an integrated clip that when rotated is located significantly inside of the body of the paint brush inside of a pocket located inside of the brush handle.

A further alternative embodiment of the present invention provides a paint brush with an integrated clip that includes a magnet, the magnet assists in attaching the clip to a metallic paint container or other metal surface.

A further alternative embodiment of the present invention provides a pocket with a deeper section that allows for the clip and clip end to be located significantly within the brush handle.

An embodiment of the present invention can be created by taking an existing paintbrush and using a material removal tool such as a chisel or drill bit to removing enough material to allow a clip to be connected to said existing brush handle with a connector.

An alternative embodiment of the present invention can be created by molding a thermoplastic material into the desired shape necessary to create the present invention. A mold must first be created which allows for inserting the desired thermoplastic material. This thermoplastic material paintbrush can allow for the creation of an embodiment of the present invention with less cost and with less steps than traditional manufacturing methods. The clip can either be connected during or after the molding process. Once the thermoplastic material has been molded into the desired shape the brush material can then be added.

In the Summary above and in the sections below, and in the accompanying drawings, reference is made to particular features of the invention. It is so understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps (except where the context excludes that possibility).

The term “at least” followed by a number is used herein to denote the start of a range beginning with that number (which may be a range having an upper limit or no upper limit, depending on the variable being defined}. For example “at least 1” means 1 or more than 1. The term “at most” followed by a number is used herein to denote the end of a range ending with that number (which may be a range having 1 or 0 as its lower limit, or a range having no lower limit, depending upon the variable then being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The invention does not require that all of the advantageous features and all the advantages need to be incorporated into every embodiment of the invention.

### DESCRIPTION OF THE DRAWINGS

FIG. 1 shows a front perspective view of an embodiment of the present invention

FIG. 2 shows a front view of a second embodiment of the present invention

FIG. 3 shows a side view of an embodiment of the present invention

FIG. 4 shows a front perspective view of an embodiment of the present invention in use.

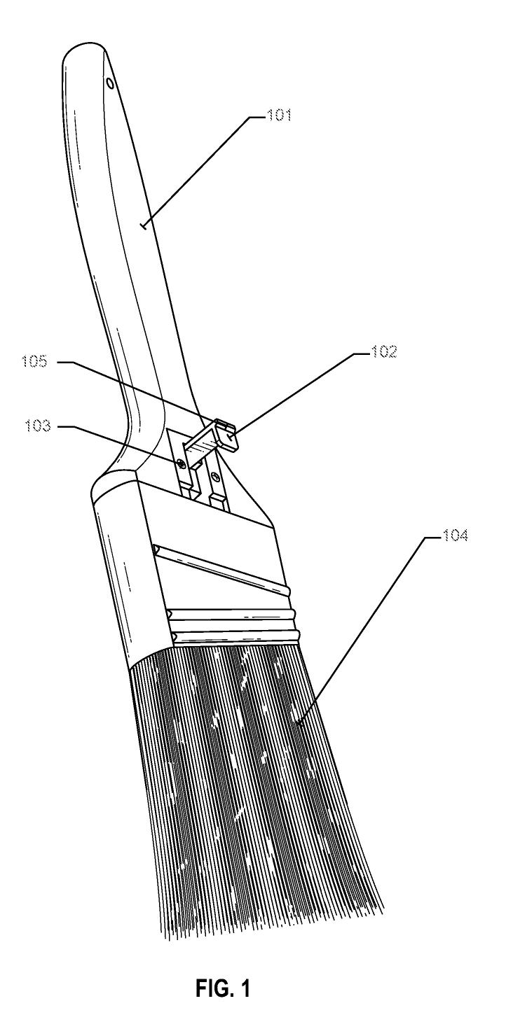

FIG. 1 shows a front perspective view of an embodiment of the present invention. A brush includes a handle 101, the handle includes a clip 102. The clip 102 is connected to the handle 101 with a connector 103. The handle is connected to a paint transferring means 104. The connector 103 allows the clip 102 to rotate around an axis.

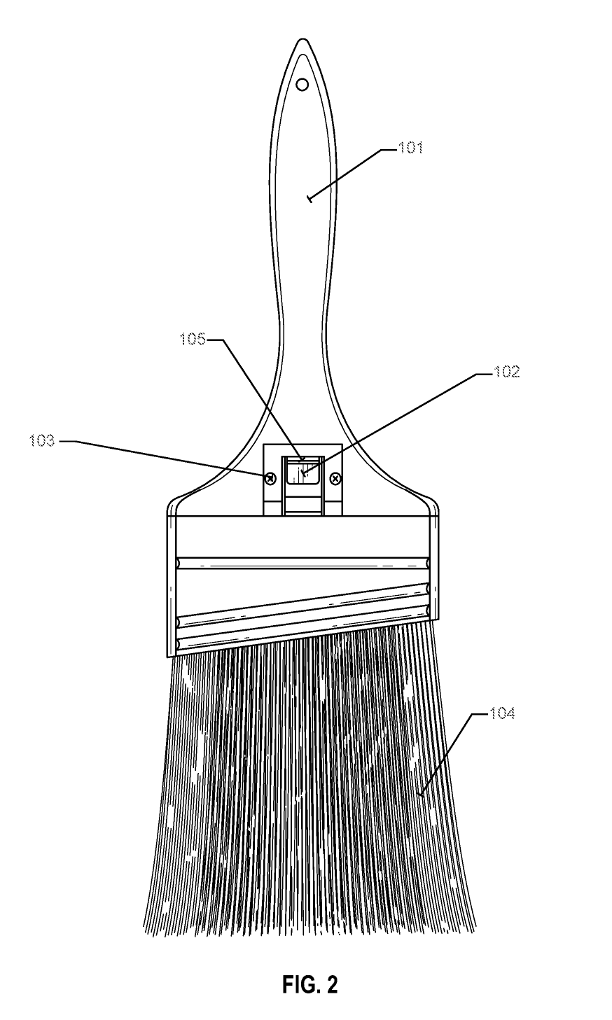

FIG. 2 shows a front view of an embodiment of the present invention. A brush includes a handle 101, the handle includes a clip 102. The clip 102 is connected to the handle 101 with a connector 103. The handle is connected to a paint transferring means 104. An embodiment of the invention includes a clip 102 which has a protrusion 105 which allows the user to more easily rotate the clip.

As shown in FIGS. 1 and 2 an embodiment of the present invention includes an integral clip which allows for the brush to be suspended from a container. The integral clip is designed in such a way as to limit interference with the use of the brush. The preferred embodiment of the present invention has an integral clip which, when not in use, can be folded within the body of the handle. An embodiment of the invention includes a clip which has a protrusion 105 which allows the user to more easily rotate the clip.

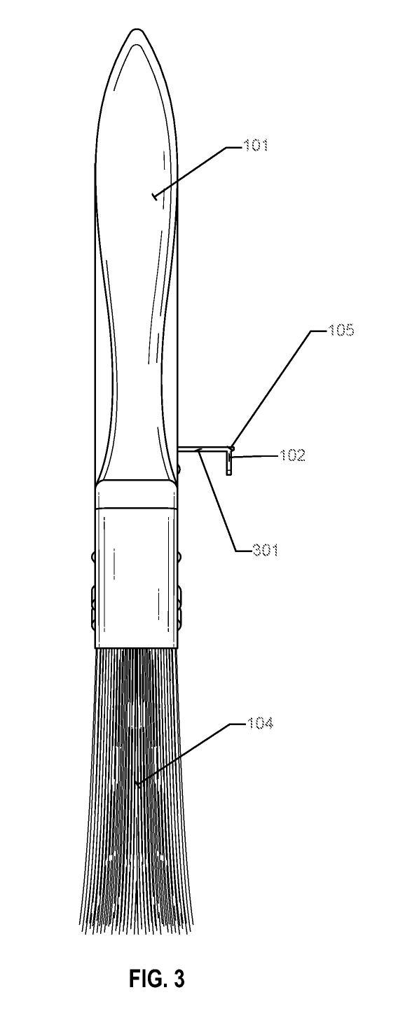

FIG. 3 shows a side view of an embodiment of the present invention. A brush includes a handle 101, the handle includes a clip 102. The clip 102 is connected to the handle 101. The handle is connected to a paint transferring means 104. The clip 102 includes an extended section 301 between said handle 101 and the end of said clip 102 which allows for the brush to be suspended over a container.

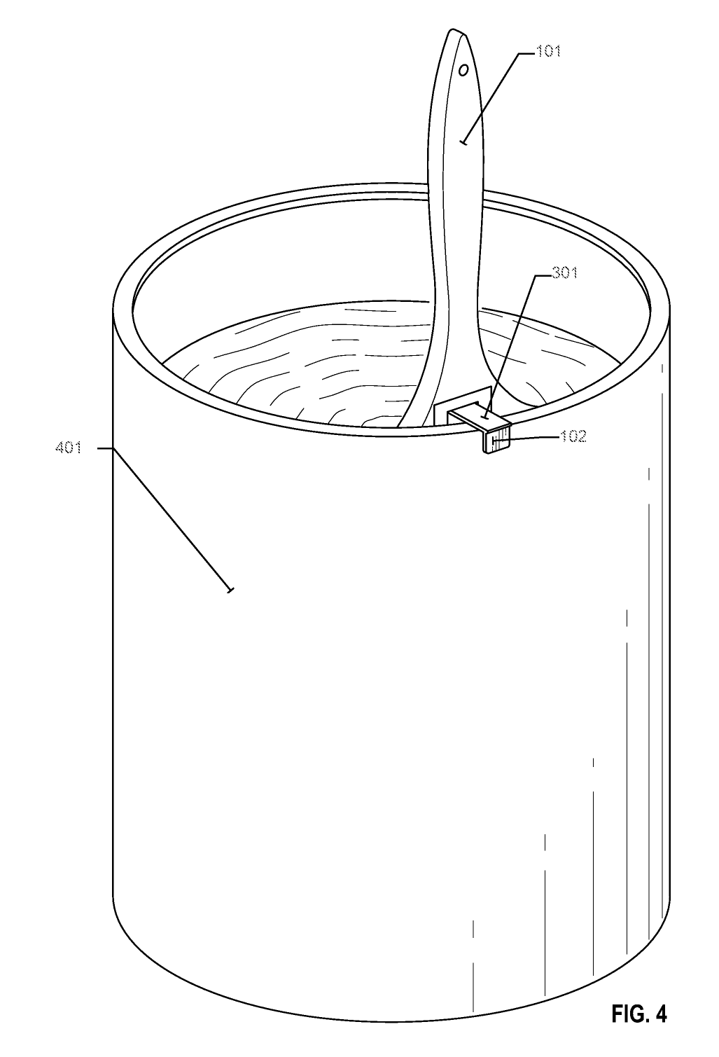

FIG. 4 shows a front view of an embodiment of the present invention in use. A bush as in FIGS. 1, 2, and 3 having an extended section 301 and a clip 102, is placed on a paint container 401. Said extended section 301 and said clip 102 suspends the brush from the paint container 401.

Although embodiments of the present invention have been described in considerable detail with reference to certain preferred versions thereof, other versions are possible. For example the clip shown which has a sharp curve, could be replaced with any other type of clip which serves the desired purpose. Therefore, the spirit and scope of this application should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features which service the same, equivalent or similar purpose, unless expressly stated otherwise. Thus, unless expressly stated otherwise, each feature disclosed is one example only of a generic series of equivalent or similar features.

What is claimed is:

1. A paintbrush comprising a handle having a front surface and rear surface, a clip, and a pocket located along said front surface of said handle; said clip being connected to said handle with a connector that is adapted to hold said clip onto said handle at an attachment point, while allowing said clip to be rotated in a position within said pocket or outside of said pocket; and said clip having a clip end and an elongated section which is located between said attachment point and said clip end.

2. The clip as in claim 1 wherein said clip is removable.

3. The handle as in claim 1 wherein said pocket further comprises: a deeper section along said front surface, which allows said clip end to be nearly flush with said front surface.

4. The clip as in claim 1 wherein said clip further comprises: a protrusion located between said elongated section and said clip end.

5. The handle as in claim 4 wherein said pocket further comprises: a deeper section along said front surface, which allows said clip end to be nearly flush with said front surface.

6. The handle as in claim 5 wherein said pocket further comprises: a deeper section along said front surface, which allows said clip end to be nearly flush with said front surface.

7. A method for manufacturing a paintbrush comprising: taking an existing paintbrush and creating a pocket in said paintbrush using a material removal tool; inserting a clip in said pocket; and connecting said clip to said paintbrush with one or more connectors.

8. A method for manufacturing a thermoplastic material paintbrush comprising: creating a mold for a paintbrush, said mold having a shape of a handle, said mold further having a shape of a clip, said handle having a pocket, said clip having a clip end; a thermoplastic material being heated and inserting said thermoplastic material into said mold; and allowing said thermoplastic material to cool.

9. The method of manufacturing of claim 8 wherein said method further comprises: removing said handle and said clip from said mold; and attaching said handle to said clip with a connector adapted to hold said clip onto said handle at an attachment point, while allowing said clip to be rotated in a position within said pocket or outside of said pocket.

10. The method of manufacturing of claim 8 wherein said method further comprises: inserting a connector within said mold prior to said thermoplastic material is allowed to cool, said connector adapted to hold said clip onto said handle at an attachment point, while allowing said clip to be rotated in a position within said pocket or outside of said pocket.
